(19) United States
(12) Patent Application Publication
(10) Pub. No.: US 2016/0026553 A1
(43) Pub. Date: Jan. 28, 2016

(54) COMPUTER WORKLOAD MANAGER

(71) Applicant: Cray Inc., Seattle, WA (US)

(72) Inventor: Peter Piela, Lexington, MA (US)

(73) Assignee: Cray Inc., Seattle, WA (US)

(21) Appl. No.: 14/337,668

(22) Filed: Jul. 22, 2014

(51) Int. Cl. G06F 11/34; G06F 17/30; G06F 11/30; G06F 9/48

(52) U.S. Cl. CPC G06F 11/3433; G06F 9/4881; G06F 17/30138; G06F 11/3017

(57) ABSTRACT

A computer-implemented method includes: scheduling computing jobs; processing data by executing the computing jobs; arranging the data in a file system; managing the arranging the data by monitoring a performance parameter of the file system and extracting information about the scheduling, and tuning one of the arranging and the scheduling based on the performance parameter and the information about the scheduling. An article of manufacture includes a computer-readable medium storing signals representing instructions for a computer program executing the method.

### BACKGROUND

The present invention relates generally to computer-implemented methods and apparatus for processing large data sets in high performance computing systems. The invention relates more specifically to accelerating application processing by providing faster access to large data sets.

### SUMMARY

A computer-implemented method, includes: scheduling computing jobs; processing data by executing the computing jobs; arranging the data in a file system; managing the arranging the data by monitoring a performance parameter of the file system and extracting information about the scheduling, and tuning one of the arranging and the scheduling based on the performance parameter and the information about the scheduling. In a variation, arranging may further include constructing a parallel file system on a cluster of Object Storage Targets (OSTs). Monitoring performance may further include identifying an overused OST. Monitoring performance may alternatively further include identifying cache misses. Identifying cache misses may yet further include identifying metadata cache misses. Monitoring performance may further include identifying an overused Meta Data Target (MDT). In another variation, extracting the information about the scheduling may further include identifying simultaneous jobs. In yet another variation, tuning the arranging may further include positioning a portion of a file in the file system to be accessible without delay at a time when required by a job. Tuning the arranging may further include modifying one or more of: striping, pooling, OST balancing, and cache usage. In yet another variation, managing the arranging further includes identifying a historical bottleneck to performance during execution of a job and re-arranging the data to avoid the bottleneck to performance during execution of the job. Managing the arranging further includes collecting information as the performance parameter one of data throughput, file system alerts, file system accounting, and file system status reporting. Alternatively, managing the arranging may further include rescheduling a computing job.

An article of manufacture may include a computer storage medium having computer program instructions stored on the computer storage medium which, when processed by a processing device, instruct the processing device to perform any of the processes or any combination of the processes described above.

In the following description, reference is made to the accompanying drawings which form a part hereof, and in which are shown example implementations. It should understood that other implementations are possible, and that these example implementations are intended to be merely illustrative.

### DESCRIPTION OF THE DRAWINGS

FIG. 1 is a high-level block diagram of aspects of an embodiment of the invention.

FIG. 2 is is a block diagram of further details of aspects of an embodiment of the invention.

FIG. 3 is a block diagram of further details of the high performance data storage system of FIG. 2.

FIG. 4 is a timing diagram of storage system activity over time produced by six example jobs.

FIG. 5 is a block diagram generically illustrating processor-based computing equipment that can be used to implement each specific element of the systems of FIGS. 1-3.

FIG. 6 is a block diagram illustrating details of the storage sub-system of the system of FIG. 5.

### DETAILED DESCRIPTION

The following section provides an example of an operating environment in which the storage workload manager can be implemented.

The operating environment includes a high performance computing system that processes computing jobs including complex and difficult computing jobs.

High performance computing systems include numerous components including computer processors, high performance storage systems, lower performance storage systems, control systems, networking systems, input and output (I/O) systems, and user interfaces. One example of an environment in which aspects of embodiments of the invention can be practiced is described in the white paper published in 2011 by Dell Inc., entitled Dell|Terascala HPC Storage Solution (DT-HSS3), by David Duncan. Elements both of the operating environment and of aspects of embodiments of the invention are described in further detail below.

A computing job may include a sequence of instructions to be performed on a specified data set to produce a desired output. For example, a sequence of instructions performed on a data set representing a complex geometric description of a mechanical part can produce a two-dimensional projection (i.e., image) of a three-dimensional representation of the stresses that the mechanical part undergoes during use. According to another example, a sequence of instructions performed on a data set representing atmospheric, ocean, and land surface data such as temperature, pressure, circulation, etc. over a period of time can produce a long-range forecast or even a projection of future climate characteristics. Many types of problems to which high performance computing systems are applied involve very large data sets. In order for the job processor to efficiently process the data set, the data required at each step should be accessible from a fast, local data storage system, but fast, local data storage is costly, so the data required by a job is moved from a slower, less costly data storage system to the fast data storage system as needed by the job.

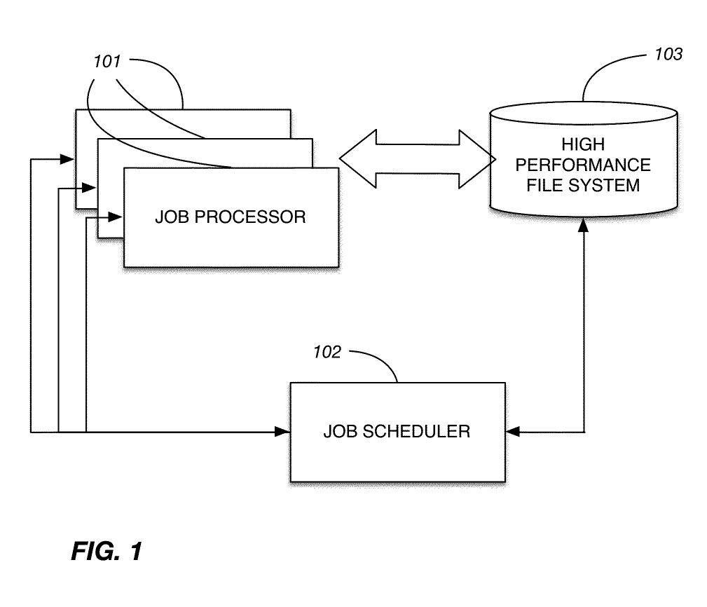

One exemplary high level description of a high performance computing system includes three components, as shown in FIG. 1. At the heart of such a computing system are one or more job processors, 101. A second component, a job scheduler, 102, manages the scheduling, delivery, and initiation of jobs in the job processors. Data for the jobs is held in a high performance data storage system, 103, the third component of the high performance computing system. Each of these three components is now further described.

The job processor, 101, is a compute engine or a cluster of compute engines that receives one or more computing jobs to be processed. Compute engines include a central processor unit (CPU), or other type of suitable processor, along with high-speed memory caches and controls for moving data and instructions into and out of the CPU. The CPU or other type of suitable processor may employ electronic, optical, quantum mechanical, or any other suitable underlying technology and logic system for performing computational work. Job processors are often called upon to either multi-task, that is, to process several distinct jobs in a manner perceived to be simultaneous to the users and operators; or, to serial process, that is, to process several distinct jobs in sequence, as perceived by the users and operators. The job scheduler, 102, performs the task of deciding which jobs to process using which techniques, and at what times.

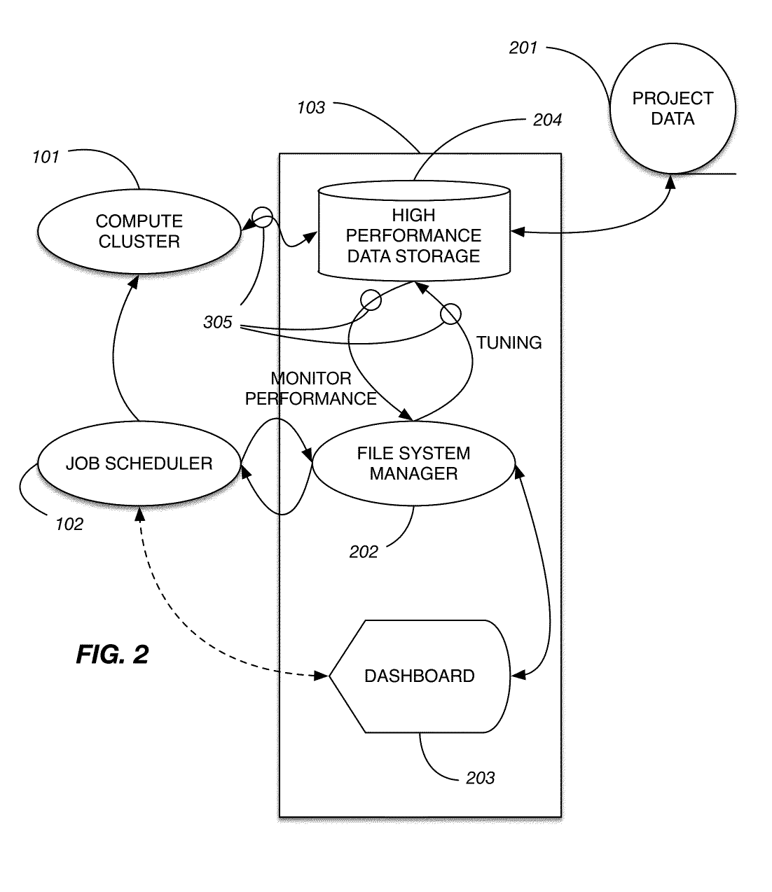

Some additional details of the basic system are now given with reference to FIG. 2.

Project data, which a computing client has been stored in an enterprise storage system, 201, is moved in and out of the high performance data storage system, 103, on the instructions given by the job scheduler, 102, through a file system manager, 202. Processing of the project data by a processor in compute cluster, 101, is executed on instructions given by the job scheduler, 102, to compute cluster, 101.

The job scheduler, 102, may be a combination of software executing on general purpose computing hardware to organize the jobs submitted by users and operators for processing so that they can be processed in an efficient manner by the job processor (part of compute cluster, 101) to which they are submitted. Conventionally, the job scheduler, 102, receives input from the operator or job creator concerning the parameters or conditions under which each job is to be performed through direct input, input from a client computing system or software process, or the like. According to one aspect, the job scheduler, 102, receives through the file system manager, 202, additional information back from the high performance data storage system, 101, concerning the performance levels and characteristics achieved by the high performance data storage system, 101, in connection with the execution of each job.

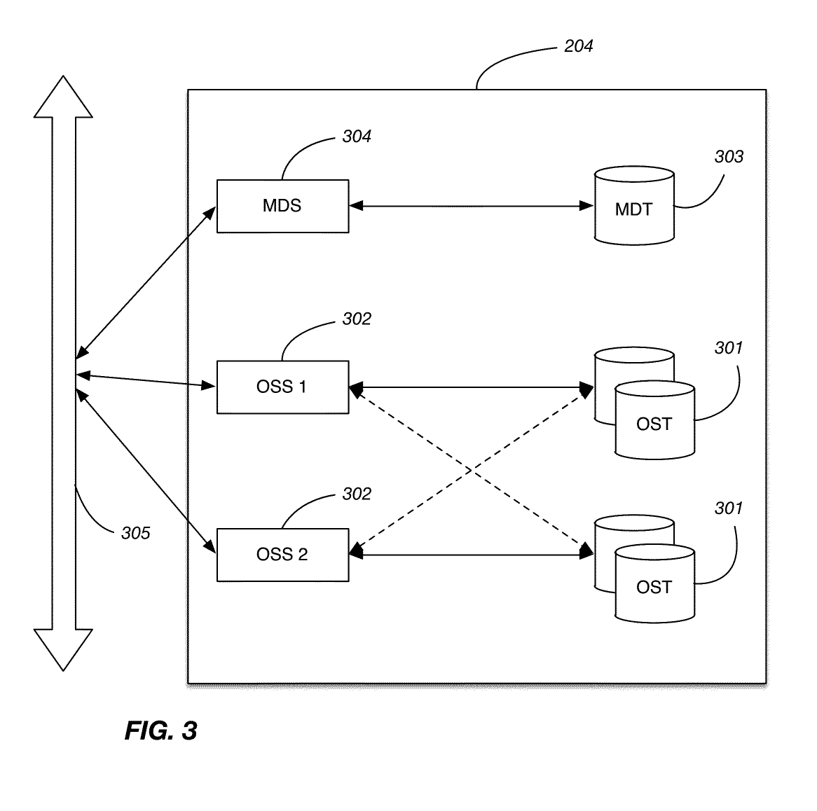

In addition to the foregoing features, the basic system may include a user interface, referred to as a dashboard, 203, by which a user or operator might observe the performance of their job, and perhaps other jobs, along with the response of the system to various kinds of tuning or adjustment, as further explained below. First, some further detail regarding the high performance data storage, 203, is given with reference to FIG. 3.

As shown in FIG. 3, a system for high performance data storage, 203, may include a number of server, connection, and storage elements. Other configurations and combinations of suitable elements could be used. The exemplary configuration used to illustrate principles of aspects of the invention include a plurality of Object Storage Targets (OSTs), 201, each of which may be a discrete unit of independently addressable storage such as a physical storage unit (e.g., a disk drive, a solid state memory, or another suitable memory unit). OSTs, 301, are connected to a plurality of Object Storage Servers (OSSs), 302, which control the flow of data to and from the OSTs. Data from a project data set is distributed over the OSTs as one or more files distributed over physical extents, for example “stripes,” on the physical media. Locations of the physical extents and their relationships to parts of the files and/or project data set as a whole are tracked through metadata stored in a MetaData Target (MDT) database, 303, referred to herein simply as the MDT. The MDT, 303, is maintained and accessed through a MetaData Server (MDS), 304. The OSSs, 302, and MDT, 304, are connected to a bus, 305, through which they communicate with the other components of the system (See, FIGS. 2, 101 and 202, for example.).

File system manager, 202, controls the placement of files within the collection of OSTs, 301, through the OSSs, 302, and adjusts that placement by issuing tuning instructions to the OSSs, 302, as needed. As the placement and tuning operations are carried out, the MDS, 304, maintains the MDT, 303, so that the project data set files, or relevant portions of those files, can be found when needed. For example, the compute cluster, 101, accesses files for processing through instructions sent over the bus, 305, to the MDS, 304, (to find the files) and the OSSs, 302, to retrieve or to save data on the relevant OSTs, 301.

Depending on the values of various performance values, statistics, and characteristics, several different tuning parameters can be adjusted, including: the striping parameters used across multiple platters and/or drives; the pooling of different jobs within a set of OSTs; balancing the use of different OSTs within the system; tuning the need for accessing metadata stored on a metadata server supporting the system, for example by recognizing applications that are poor fits to the high performance parallel file system; and, adjusting caching parameters, since swamping the cache under Linux can require excessive access to the metadata server, while simple look ahead can be wasteful of both cache space and ultimately of cache moves.

The file system manager, 202, collects information on cache hits and misses, requests to the MDS, 304, requests to each OSS, 302, and transfers into and out of each OST, 301. As the file system manager, 202, detects inefficient use of any of the above components, the MDS, 304, OSSs, 302, or OSTs, 301, it causes files and file segments to be relocated for efficient access, as described below. Moreover, data collected by the file system manager, 202, optionally shared with the job scheduler, 102, permits the job scheduler, 102, to reschedule repetitive jobs having characteristics that cause inherent inefficiency to avoid conflicting behavior.

One performance parameter, namely overuse of one or more OSTs can indicate various kinds of competition for the OST. For example, if two or more compute jobs are competing for the same OST, it may be that access to a file belonging to one of the compute jobs is competing with, and interfering with, access to a file belonging to another of the compute jobs. Those jobs should be rescheduled to use different OSTs, if possible, disrupting the interference. If there is only one job causing overuse of an OST, that job may have two or more files interfering in the same manner as described in connection with two or more competing compute jobs. The remedy is similar - the files could be moved to separate OSTs, where the competing access does not cause overuse of either. Alternatively, a single job causing overuse of an OST may have a single file that is poorly striped.

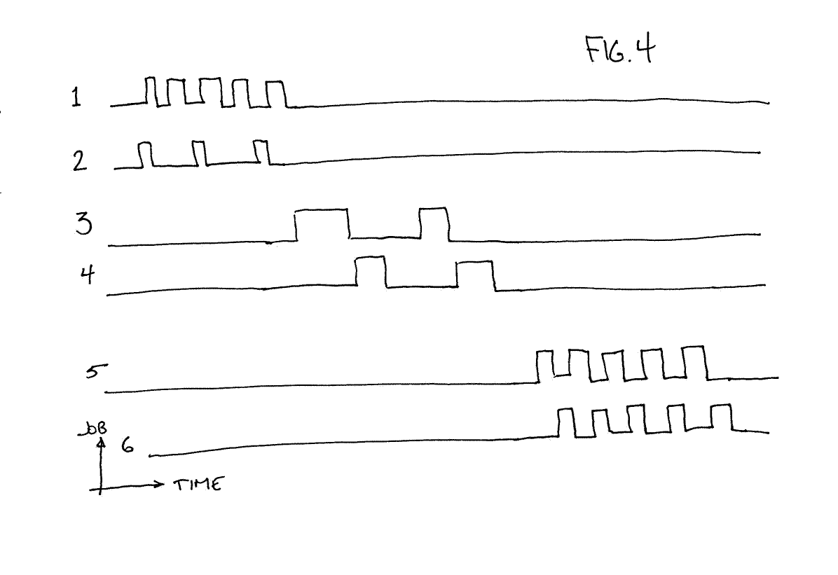

Reference is now made to FIG. 4, which illustrate examples of various OST access patterns. In FIG. 4, the jobs have been scheduled to avoid conflicts. Jobs 1 and 2, Jobs 3 and 4, and Jobs 5 and 6 each have patterns that allow OST accesses to be interwoven to avoid conflict. It may be seen that if Job 1 had been scheduled for processing in parallel with one of Jobs 3 or 4, then each of those jobs would be slowed substantially due to access conflicts. A job with an access pattern such as Job 1 could be envisioned to require that its files be spread over a number of OSTs by restriping, so that rapid, repeated accesses do not slow down the processing of Job 1.

The system for adjusting the various tuning parameters includes a learning component. The learning component analyses the historical behavior of an application and uses that analysis to then tune and schedule data services and jobs run by that application. The learning component is a form of feedback loop that determines from the history of scheduling for various jobs belonging to various applications, which jobs and applications can be run together or share OSTs, and which should be separated. The granularity of the history information examined can include which files belonging to certain applications tend to cause problems either alone or when run or stored together with other files belonging to the same or other applications, and which are better behaved.

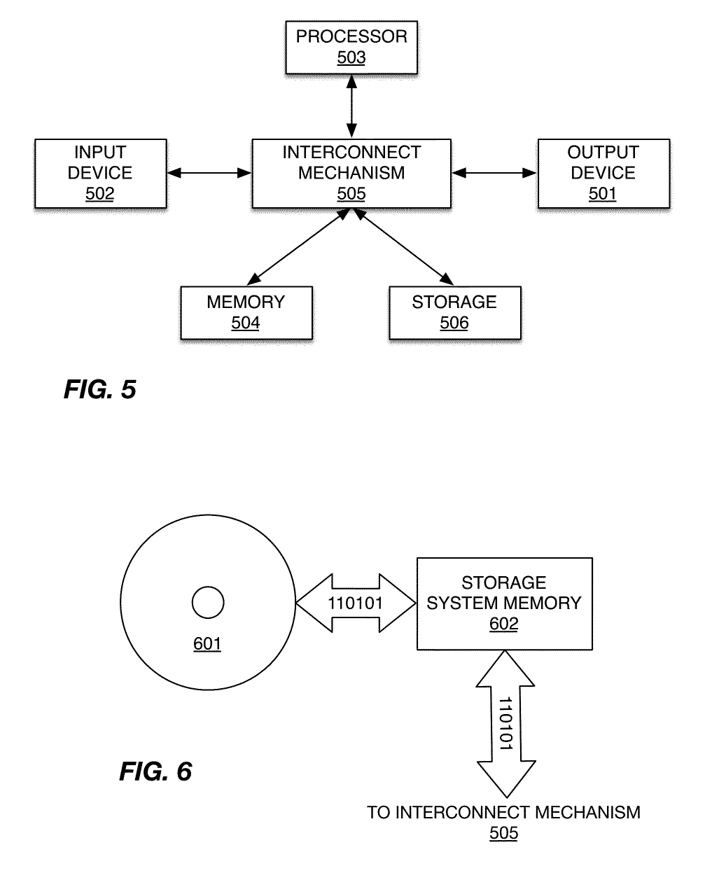

Various hardware components described above, including job processors, job schedulers, various servers, storage systems and the like may each be implemented as specialized software executing in a general-purpose computer system 500 such as that shown in FIG. 5. The computer system 500 may include a processor 503 connected to one or more memory devices 504, such as a disk drive, memory, or other device for storing data. Memory 504 is typically used for storing programs and data during operation of the computer system 500. Components of computer system 500 may be coupled by an interconnection mechanism 504, which may include one or more busses (e.g., between components that are integrated within a same machine) and/or a network (e.g., between components that reside on separate discrete machines). The interconnection mechanism 505 enables communications (e.g., data, instructions) to be exchanged between system components of system 500.

Computer system 500 also includes one or more input devices 502, for example, a keyboard, mouse, trackball, microphone, touch screen, and one or more output devices 501, for example, a printing device, display screen, speaker. In addition, computer system 500 may contain one or more interfaces (not shown) that connect computer system 500 to a communication network (in addition or as an alternative to the interconnection mechanism 505. Depending on the particular use to which the system 500 is to be put, one or more of the components described can optionally be omitted, or one or more of the components described can be highly specialized to accomplish the particular use. For example, a storage system may not have separate input devices and output devices; those may be combined in a communication system employing a high-speed bus or network to move data and instructions between the storage system and a data consumer.

The storage system 506, shown in greater detail in FIG. 6, typically includes a computer readable and writeable nonvolatile recording medium 601 in which signals are stored that define instructions that taken together form a program to be executed by the processor or information stored on or in the medium 601 to be processed by the program. The medium may, for example, be a disk or flash memory. Optionally, the medium may be read-only, thus storing only instructions and static data for performing a specialized task. Typically, in operation, the processor causes data to be read from the nonvolatile recording medium 601 into another memory 602 that allows for faster access to the information by the processor than does the medium 601. This memory 602 is typically a volatile, random access memory such as a dynamic random access memory (DRAM) or static memory (SRAM). It may be located in storage system 506, as shown, or in memory system 504, not shown. The processor 503 generally manipulates the data within the integrated circuit memory 504, 602 and then copies the data to the medium 501 after processing is completed. A variety of mechanisms are known for managing data movement between the medium 601 and the integrated circuit memory element 504, 602, and the invention is not limited thereto. The invention is not limited to a particular memory system 504 or storage system 506.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 500 is shown by way of example as one type of computer system upon which various aspects of the invention may be practiced, it should be appreciated that aspects of the invention are not limited to being implemented on the computer system as shown in FIG. 5. Various aspects of the invention may be practiced on one or more computers having a different architecture or components that that shown in FIG. 5.

Computer system 500 may be a general-purpose computer system that is programmable using a high-level computer programming language. Computer system 500 may be also implemented using specially programmed, special purpose hardware. In computer system 500, processor 503 may be any suitable processor for the task at hand. An executive or operating system on which a work program is layered may control the processor. Any suitable executive or operating system may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java , C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

What is claimed is:

1. A computer-implemented method, comprising:
scheduling computing jobs;
processing data by executing the computing jobs;
arranging the data in a file system;
managing the arranging the data by monitoring a performance parameter of the file system and extracting information about the scheduling, and tuning one of the arranging and the scheduling based on the performance parameter and the information about the scheduling.

2. The computer-implemented method of claim 1, arranging further comprising:
constructing a parallel file system on a cluster of Object Storage Targets (OSTs).

3. The computer-implemented method of claim 2, monitoring performance further comprising:
identifying an overused OST.

4. The computer-implemented method of claim 2, monitoring performance further comprising:
identifying cache misses.

5. The computer-implemented method of claim 4, identifying cache misses further comprising:
identifying metadata cache misses.

6. The computer-implemented method of claim 2, monitoring performance further comprising:
identifying an overused Meta Data Target (MDT).

7. The computer-implemented method of claim 1, extracting the information about the scheduling further comprising:
identifying simultaneous jobs.

8. The computer-implemented method of claim 1, tuning the arranging further comprising:
positioning a portion of a file in the file system to be accessible without delay at a time when required by a job.

9. The computer-implemented method of claim 8, tuning the arranging further comprising:
modifying one or more of: striping, pooling, OST balancing, and cache usage.

10. The computer-implemented method of claim 1, managing the arranging further comprising:
identifying a historical bottleneck to performance during execution of a job and re-arranging the data to avoid the bottleneck to performance during execution of the job.

11. The computer-implemented method of claim 10, managing the arranging further comprising:
collecting information as the performance parameter one of data throughput, file system alerts, file system accounting, and file system status reporting.

12. The computer-implemented method of claim 10, managing the arranging further comprising:
rescheduling a computing job.

13. An article of manufacture comprising:
a computer storage medium;
computer program instructions stored on the computer storage medium which, when processed by a processing device, instruct the processing device to perform a process comprising:
scheduling computing jobs;
processing data by executing the computing jobs;
arranging the data in a file system;
managing the arranging the data by monitoring a performance parameter of the file system and extracting information about the scheduling, and tuning one of the arranging and the scheduling based on the performance parameter and the information about the scheduling.

14. The article of claim 13, arranging further comprising:
constructing a parallel file system on a cluster of Object Storage Targets (OSTs).

15. The article of claim 14, monitoring performance further comprising:
identifying an overused OST.

16. The computer-implemented method of claim 14, monitoring performance further comprising:
identifying cache misses.

17. The article of claim 16, identifying cache misses further comprising:
identifying metadata cache misses.

18. The article of claim 14, monitoring performance further comprising:
identifying an overused Meta Data Target (MDT).

19. The article of claim 13, extracting the information about the scheduling further comprising:
identifying simultaneous jobs.

20. The article of claim 13, tuning the arranging further comprising:
positioning a portion of a file in the file system to be accessible without delay at a time when required by a job.

21. The article of claim 20, tuning the arranging further comprising:
modifying one or more of: striping, pooling, OST balancing, and cache usage.

22. The article of claim 13, managing the arranging further comprising:
identifying a historical bottleneck to performance during execution of a job and re-arranging the data to avoid the bottleneck to performance during execution of the job.

23. The article of claim 22, managing the arranging further comprising:
collecting information as the performance parameter one of data throughput, file system alerts, file system accounting, and file system status reporting.

24. The article of claim 22, managing the arranging further comprising:
rescheduling a computing job.
